(19) United States
(12) Patent Application Publication
(10) Pub. No.: US 2025/0132838 A1
(43) Pub. Date: Apr. 24, 2025

(54) CONTROL DEVICE FOR OPTICAL TRANSMITTER, OPTICAL TRANSCEIVER, AND CONTROL METHOD FOR OPTICAL TRANSMITTER

(71) Applicant: NEC Corporation, Minato-ku, Tokyo (JP)

(72) Inventor: Masayuki NAKANO, Tokyo (JP)

(73) Assignee: NEC Corporation, Minato-ku, Tokyo (JP)

(21) Appl. No.: 18/690,405

(22) PCT Filed: Sep. 24, 2021
(86) PCT No.: PCT/JP2021/035026

§ 371 Date: Mar. 8, 2024

(51) Int. Cl. H04B 10/572; H04B 10/564

(52) U.S. Cl. CPC H04B 10/572; H04B 10/564

(57) ABSTRACT

The control device for an optical transmitter includes a control signal generator configured to generate a control signal that specifies a power value to be consumed by a heating element used for temperature control of the optical transmitter and a power generator configured to generate supply power with the power value according to the control signal.

### TECHNICAL FIELD

The present invention relates to a control device for an optical transmitter, an optical transceiver, and a control method for an optical transmitter, particularly to a control device for an optical transmitter, an optical transceiver, and a control method for an optical transmitter that are used in wavelength division multiplexing communication.

### BACKGROUND ART

In recent years, as information communication services have become more sophisticated and diversified, an optical communication system has been required to have higher capacity. For this reason, in the optical communication system, a wavelength division multiplexing (WDM) method by which transmission capacity per fiber can be increased is employed. Further, in wavelength division multiplexing (WDM) communication, an optical transceiver equipped with a wavelength-tunable laser that can oscillate at any wavelength within a wavelength band to be used is used. An example of such an optical transceiver is described in PTL 1.

Further, as a related technique, techniques described in PTLs 2 to 4 exist.

### CITATION LIST

### Patent Literature

[PTL 1] Japanese Unexamined Patent Application Publication No. 2019-040099
[PTL 2] Japanese Unexamined Patent Application Publication No. 2006-020364
[PTL 3] Japanese Unexamined Patent Application Publication No. 2010-103293
[PTL 4] Japanese Unexamined Patent Application Publication No. 2016-129207

### SUMMARY OF INVENTION

### Technical Problem

An electrical interface, a shape (form factor), a pin assignment, and the like of an optical transceiver are specified in an industry standard specification called multi source agreement (MSA). Currently, a small form factor pluggable (SFP) optical transceiver that is live-line pluggable and live-line unpluggable is mainly used.

Meanwhile, as an optical communication system is increased in capacity, an optical transceiver is required to be increased in communication speed. As a result, a circuit size and power consumption of an optical transceiver tend to increase.

Therefore, in order to increase communication speed while adopting an electrical interface and a shape (package size) of an optical transceiver to a standard specification, a component of the optical transceiver needs to be reduced in size and power consumption.

Thus, there is a problem that a component in an optical transceiver needs to be reduced in size and power consumption.

In view of the above-described problem, an object of the present invention is to provide a control device for an optical transmitter, an optical transceiver, and a control method for an optical transmitter that solve a problem that a component in an optical transceiver needs to be reduced in size and power consumption.

### Solution to Problem

A control device for an optical transmitter according to the present invention includes: a control signal generation means for generating a control signal specifying a power value to be consumed by a heating element to be used for temperature control of an optical transmitter; and a power generation means for generating supply power being power of the power value, according to the control signal.

An optical transceiver according to the present invention includes: an optical transmitter including a heating element to be used for temperature control; and a control device configured to control the optical transmitter, and the control device includes a control signal generation means for generating a control signal specifying a power value to be consumed by the heating element, and a power generation means for generating supply power being power of the power value, according to the control signal.

A control method for an optical transmitter according to the present invention includes: generating a control signal specifying a power value to be consumed by a heating element to be used for temperature control of an optical transmitter; and generating supply power being power of the power value, according to the control signal.

### Advantageous Effects of Invention

According to the control device for an optical transmitter, the optical transceiver, and the control method for an optical transmitter of the present invention, a component of the optical transceiver can be reduced in size and power consumption.

### BRIEF DESCRIPTION OF DRAWINGS

FIG. 1 is a block diagram illustrating a configuration of a control device for an optical transmitter according to a first example embodiment of the present invention.

FIG. 2 is a block diagram illustrating another configuration of the control device for an optical transmitter according to the first example embodiment of the present invention.

FIG. 3 is a block diagram of a configuration of an optical transceiver according to a second example embodiment of the present invention.

FIG. 4 is a block diagram illustrating another configuration of the optical transceiver according to the second example embodiment of the present invention.

FIG. 5 is a block diagram illustrating another configuration of the optical transceiver according to the second example embodiment of the present invention.

### EXAMPLE EMBODIMENT

In the following, the example embodiments of the present invention will be described with reference to the drawings.

### First Example Embodiment

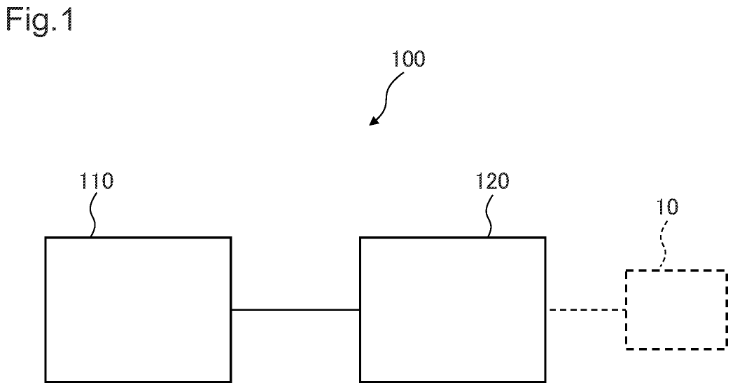

FIG. 1 is a block diagram illustrating a configuration of a control device 100 for an optical transmitter according to a first example embodiment of the present invention. The control device 100 for an optical transmitter includes a control signal generation unit (control signal generation means) 110 and a power generation unit (power generation means) 120.

The control signal generation unit 110 is configured in such a way as to generate a control signal specifying a power value to be consumed by a heating element 10 used for temperature control of an optical transmitter. Further, the power generation unit 120 is configured in such a way as to generate supply power being power of the power value, according to the control signal.

Thus, the control device 100 for an optical transmitter according to the present example embodiment is configured in such a way that the power generation unit 120 generates supply power of a power value to be consumed by the heating element 10 used for temperature control. Therefore, a Peltier element and a driver circuit such as a Peltier element driver circuit used for temperature control (for example, see PTL 2) are not necessary. Consequently, by using the control device 100 for an optical transmitter according to the present example embodiment, a component of an optical transceiver can be reduced in size and power consumption. Therefore, it is possible to improve communication speed while adapting an electrical interface and a shape (package size) of the optical transceiver to a standard specification.

Herein, the power generation unit 120 can be configured in such a way as to supply the supply power directly to the heating element 10.

In this case, it is not necessary to provide a driver amplifier and the like in a subsequent stage of the power generation unit 120. Therefore, the control device 100 for an optical transmitter can be reduced in size and power consumption.

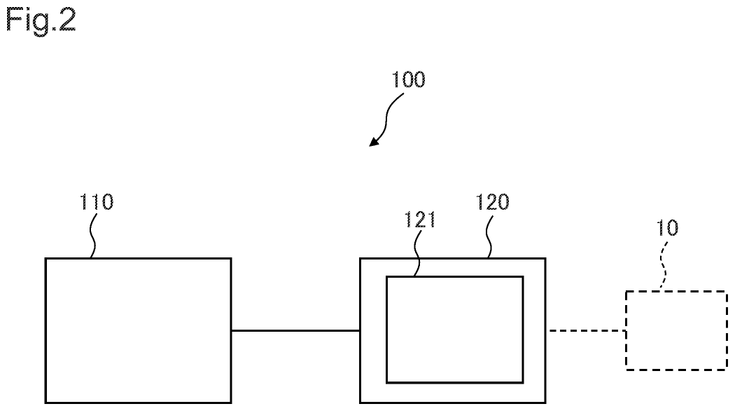

As illustrated in FIG. 2, the power generation unit 120 can be configured in such a way as to include a digital-to-analog conversion unit (digital-to-analog conversion means) 121 that converts the above-described control signal being a digital signal into an analog signal of the above-described power value. The digital-to-analog conversion unit 121 is typically a D/A converter (digital-to-analog converter: DAC). Thus, by employing a configuration in which the D/A converter (DAC) as the power generation unit 120 generates supply power of the power value to be consumed by the heating element 10, an error of the above-described power value can be minimized. Therefore, the power value can be controlled with high accuracy and a maximum applied voltage can be reduced. Consequently, it is possible to reduce power consumption of the control device 100 for an optical transmitter.

Specifically, for example, a case is considered in which a transmission wavelength of an optical transmitter is controlled by temperature control using the heating element 10. In this case, when control accuracy of supply power is 1 milliwatt per channel (mW/ch), for example, a maximum voltage of 5 volts (V) is required in order to control a 50 wavelengths channel when a maximum supply current is 10 milliamperes (mA). Meanwhile, when a high accuracy of 0.6 milliwatt per channel (mW/ch) is obtained by using a D/A converter (DAC), the maximum voltage required to control the 50 wavelengths channel can be reduced to 3 volts (V). Thus, power consumption of the control device 100 for an optical transmitter can be reduced by using a D/A converter (DAC).

The control signal generation unit 110 can be configured in such a way as to generate, based on a relation between a wavelength of transmitted light output from the optical transmitter and the power value, the control signal in such a way that the wavelength of the transmitted light becomes a desired wavelength. This power value is the power value to be consumed by the above-described heating element 10 used for temperature control of an optical transmitter.

The control signal generation unit 110 can be configured in such a way as to include a storage unit (memory) storing a lookup table (LUT) in which the above-described relation between the wavelength and the power value of the transmitted light is stored. Note that, the lookup table (LUT) may store a relation between the wavelength of the transmitted light and an output voltage of the D/A converter (DAC). Herein, the control signal generation unit 110 is typically a micro controller unit (MCU). Further, the control signal generation unit 110 can be configured in such a way as to transmit the control signal being a digital signal to the power generation unit 120.

Next, a control method for an optical transmitter according to the present example embodiment will be described.

In the control method for an optical transmitter according to the present example embodiment, first, a control signal specifying a power value to be consumed by a heating element used for temperature control of an optical transmitter is generated. Further, according to the control signal, supply power being power of the power value is generated.

Thus, the control method for an optical transmitter according to the present example embodiment is configured in such a way that supply power of a power value to be consumed by a heating element used for temperature control is generated. Therefore, a driver circuit used for temperature control is not necessary. Consequently, by using the control method for an optical transmitter according to the present example embodiment, a component of an optical transceiver can be reduced in size and power consumption. Therefore, it is possible to improve communication speed while adopting an electrical interface and a shape (package size) of the optical transceiver to a standard specification.

The above-described supply power generation can include supplying the supply power directly to the heating element. Further, the supply power generation may include converting the above-described control signal being a digital signal into an analog signal of the above-described power value.

Further, the above-described control signal generation can include generating, based on a relation between a wavelength of transmitted light output from the optical transmitter and the above-described power value, the control signal in such a way that the wavelength of the transmitted light becomes a desired wavelength.

As described above, by using the control device 100 for an optical transmitter and the control method for an optical transmitter according to the present example embodiment, a component of an optical transceiver can be reduced in size and power consumption.

### Second Example Embodiment

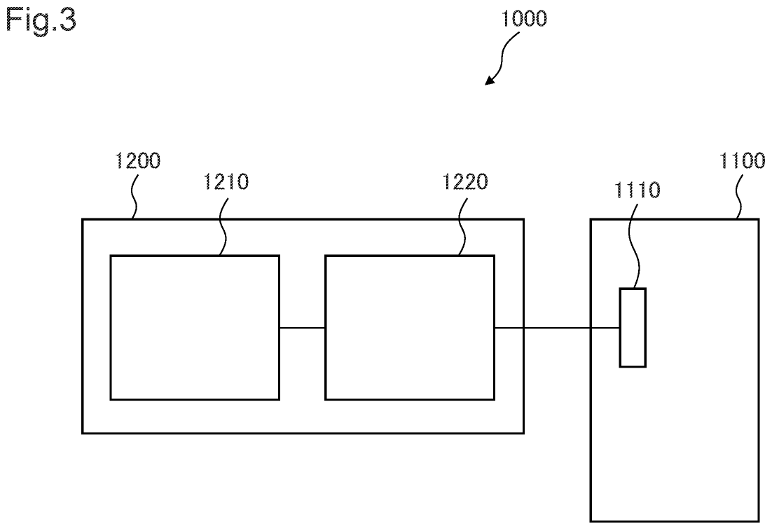

Next, a second example embodiment of the present invention will be described. A configuration of an optical transceiver 1000 according to the present example embodiment is illustrated in FIG. 3. The optical transceiver 1000 includes an optical transmitter 1100 and a control device 1200. The control device for an optical transmitter according to the first example embodiment can be used as the control device 1200.

The optical transmitter 1100 includes a heating element 1110 used for temperature control.

The control device 1200 is configured in such a way as to control the optical transmitter 1100. Further, the control device 1200 includes a control signal generation unit (control signal generation means) 1210 and a power generation unit (power generation means) 1220. Herein, the control signal generation unit 1210 is configured in such a way as to generate a control signal specifying a power value to be consumed by the heating element 1110. Further, the power generation unit 1220 is configured in such a way as to generate supply power being power of the power value, according to the control signal.

Thus, the optical transceiver 1000 according to the present example embodiment is configured in such a way that the power generation unit 1220 included in the control device 1200 generates supply power of a power value to be consumed by the heating element 1110 used for temperature control. Therefore, a Peltier element and a driver circuit such as a Peltier element driver circuit (for example, see PTL 2) used for temperature control are not necessary. Consequently, by using the optical transceiver 1000 according to the present example embodiment, a component can be reduced in size and power consumption. Therefore, it is possible to improve communication speed while adopting an electrical interface and a shape (package size) of the optical transceiver 1000 to a standard specification.

Herein, the power generation unit 1220 can be configured in such a way as to supply the supply power directly to the heating element 1110. In this case, it is not necessary to provide a driver amplifier and the like in between the power generation unit 1220 and the heating element 1110. Therefore, a component of the optical transceiver 1000 can be reduced in size and power consumption.

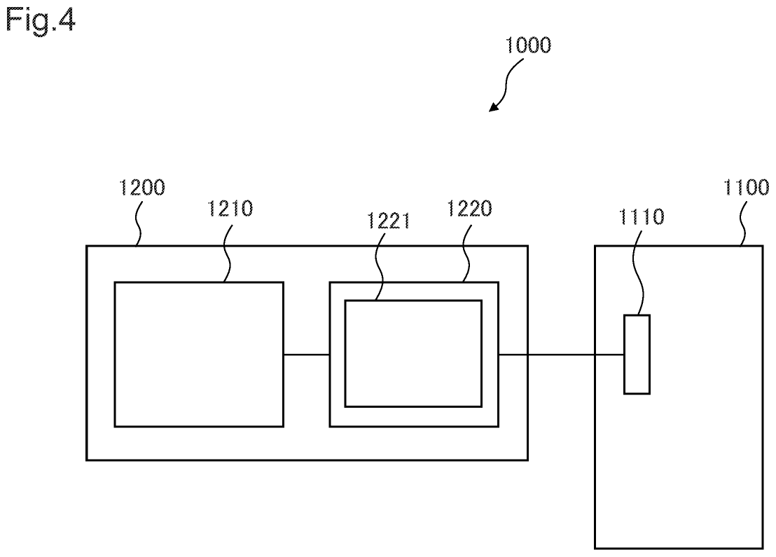

As illustrated in FIG. 4, the power generation unit 1220 can be configured in such a way as to include a digital-to-analog conversion unit (digital-to-analog conversion means) 1221 that converts the above-described control signal being a digital signal into an analog signal of the above-described power value. The digital-to-analog conversion unit 1221 is typically a digital-to-analog converter (D/A converter: DAC). Thus, by employing a configuration in which the D/A converter (DAC) as the power generation unit 1220 generates supply power of the power value to be consumed by the heating element 1110, an error of the above-described power value can be minimized. Therefore, the power value can be controlled with high accuracy and a maximum applied voltage can be reduced. Consequently, it is possible to reduce power consumption of the control device 1200.

Herein, the heating element 1110 can be configured in such a way as to include a heater resistor. Further, a resistance value of this heater resistor can be defined based on drive capacity of the digital-to-analog conversion unit 1221. Specifically, when the resistance value of the heater resistor is too large, even when the digital-to-analog conversion unit 1221 outputs a maximum output voltage, a maximum power consumed by the heater resistor cannot be supplied. Further, when the resistance value of the heater resistor is too small, even when the digital-to-analog conversion unit 1221 outputs a maximum output current, the maximum power to be consumed by the heater resistor cannot be supplied. By using the optical transceiver 1000 according to the present example embodiment, it is possible to supply the heating element 1110 with the maximum power to be consumed, because the resistance value of the heater resistor is defined based on the drive capacity (maximum output voltage, maximum output current) of the digital-to-analog conversion unit 1221.

The control signal generation unit 1210 can be configured in such a way as to generate, based on a relation between a wavelength of transmitted light output from the optical transmitter 1100 and the power value, the control signal in such a way that the wavelength of the transmitted light becomes a desired wavelength. This power value is the above-described power value to be consumed by the heating element 1110 used for temperature control of the optical transmitter 1100.

The control signal generation unit 1210 can be configured in such a way as to include a storage unit (memory) storing a lookup table (LUT) in which the above-described relation between the wavelength of the transmitted light and the power value is stored. Note that, the lookup table (LUT) may store a relation between the wavelength of the transmitted light and an output voltage of the D/A converter (DAC). Herein, the control signal generation unit 1210 is typically a micro controller unit (MCU). Further, the control signal generation unit 1210 can be configured in such a way to transmit the control signal being a digital signal to the power generation unit 1220.

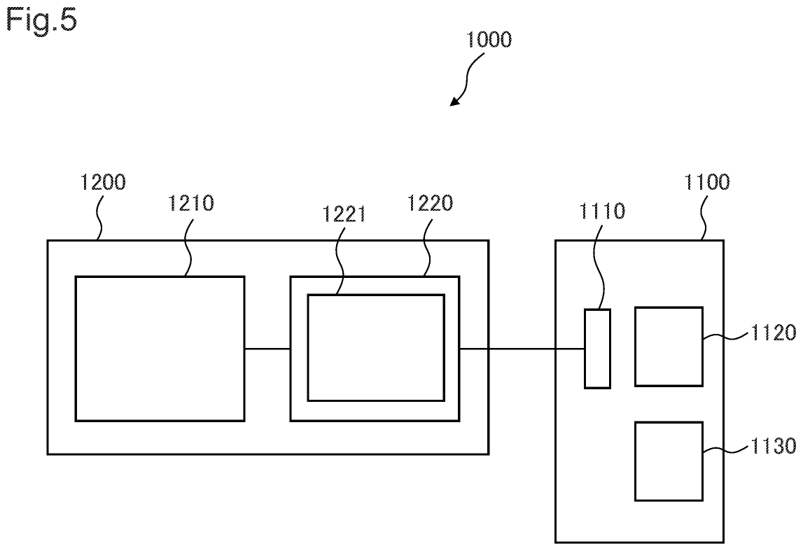

As illustrated in FIG. 5, the optical transmitter 1100 further includes a wavelength-tunable light source 1120 and an optical modulator 1130. The wavelength-tunable light source 1120 includes a wavelength-tunable filter using, for example, a ring resonator. In this case, at least the wavelength-tunable light source 1120 can be configured in such a way as to be placed in proximity of the heating element 1110. By employing such a configuration, a wavelength of output light from the wavelength-tunable light source 1120 can be changed by controlling a transmitted wavelength of the wavelength-tunable filter by changing a refractive index through temperature change caused by the heating element 1110.

Further, the heating element 1110 may be configured in such a way as to be placed in proximity of the optical modulator 1130 or another component of the optical transceiver 1000. As described above, the optical transceiver 1000 according to the present example embodiment is configured in such a way that the power generation unit 1220 generates supply power of a power value to be consumed by the heating element 1110 used for temperature control and supplies the supply power to the heating element 1110. Therefore, a Peltier element and a driver circuit such as a Peltier element driver circuit used for temperature control are not necessary. Therefore, a component of the optical transceiver 1000 can be reduced in size and power consumption, even when the heating element 1110 is placed in proximity of the optical modulator 1130 and the like.

As described above, by using the optical transceiver 1000 according to the present example embodiment, a component of an optical transceiver optical transceiver can be reduced in size and power consumption.

A part or the entirety of the above-described example embodiments may be described as the following supplementary notes, but is not limited thereto.

### (Supplementary Note 1)

A control device for an optical transmitter, including: a control signal generation means for generating a control signal specifying a power value to be consumed by a heating element to be used for temperature control of an optical transmitter; and a power generation means for generating supply power being power of the power value, according to the control signal.

### (Supplementary Note 2)

The control device for an optical transmitter according to Supplementary note 1, wherein the power generation means is configured in such a way as to supply the supply power directly to the heating element.

### (Supplementary Note 3)

The control device for an optical transmitter according to Supplementary note 1 or 2, wherein the power generation means includes a digital-to-analog conversion means for converting the control signal being a digital signal into an analog signal of the power value.

### (Supplementary Note 4)

The control device for an optical transmitter according to any one of Supplementary notes 1 to 3, wherein the control signal generation means is configured in such a way as to generate, based on a relation between a wavelength of transmitted light being output from the optical transmitter and the power value, the control signal in such a way that the wavelength becomes a desired wavelength.

### (Supplementary Note 5)

An optical transceiver including: an optical transmitter including a heating element to be used for temperature control; and a control device configured to control the optical transmitter, wherein the control device includes a control signal generation means for generating a control signal specifying a power value to be consumed by the heating element, and a power generation means for generating supply power being power of the power value.

### (Supplementary Note 6)

The optical transceiver according to Supplementary note 5, wherein the power generation means is configured in such a way as to supply the supply power directly to the heating element.

### (Supplementary Note 7)

The optical transceiver according to Supplementary note 5 or 6, wherein the power generation means includes a digital-to-analog conversion means for converting the control signal being a digital signal into an analog signal of the power value.

### (Supplementary Note 8)

The optical transceiver according to Supplementary note 7, wherein the heating element includes a heater resistor, and a resistance value of the heater resistor is defined based on drive capacity of the digital-to-analog conversion means.

### (Supplementary Note 9)

The optical transceiver according to any one of Supplementary notes 5 to 8, wherein the control signal generation means is configured in such a way as to generate, based on a relation between a wavelength of transmitted light being output from the optical transmitter and the power value, the control signal in such a way that the wavelength becomes a desired wavelength.

### (Supplementary Note 10)

The optical transceiver according to any one of Supplementary notes 5 to 9, wherein the optical transmitter further includes a wavelength-tunable light source and an optical modulator, and at least the wavelength-tunable light source is placed in proximity of the heating element.

### (Supplementary Note 11)

A control method for an optical transmitter, including: generating a control signal specifying a power value to be consumed by a heating element to be used for temperature control of an optical transmitter; and generating supply power being power of the power value, according to the control signal.

### (Supplementary Note 12)

The control method for an optical transmitter according to Supplementary note 11, wherein the generating the supply power includes supplying the supply power directly to the heating element.

### (Supplementary Note 13)

The control method for an optical transmitter according to Supplementary note 11 or 12, wherein the generating the supply power includes converting the control signal being a digital signal into an analog signal of the power value.

### (Supplementary Note 14)

The control method for an optical transmitter according to any one of Supplementary notes 11 to 13, wherein the generating the control signal includes generating, based on a relation between a wavelength of transmitted light being output from the optical transmitter and the power value, the control signal in such a way that the wavelength becomes a desired wavelength.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

100 Control device for optical transmitter
110 Control signal generation unit
120 Power generation unit
121 Digital-to-analog conversion unit
10, 1110 Heating element
1000 Optical transceiver
1100 Optical transmitter
1120 Wavelength-tunable light source
1130 Optical modulator
1200 Control device
1210 Control signal generation unit
1220 Power generation unit
1221 Digital-to-analog conversion unit

What is claimed is:

1. A control device for an optical transmitter, comprising:
a control signal generator configured to generate a control signal specifying a power value to be consumed by a heating element to be used for temperature control of an optical transmitter; and
a power generator configured to generate supply power being power of the power value, according to the control signal.

2. The control device for an optical transmitter according to claim 1, wherein
the power generator is configured to supply the supply power directly to the heating element.

3. The control device for an optical transmitter according to claim 1, wherein
the power generator includes digital-to-analog converter configured to convert the control signal being a digital signal into an analog signal of the power value.

4. The control device for an optical transmitter according to claim 1, wherein
the control signal generator is configured to generate, based on a relation between a wavelength of transmitted light being output from the optical transmitter and the power value, the control signal in such a way that the wavelength becomes a desired wavelength.

5. An optical transceiver comprising:
an optical transmitter including a heating element to be used for temperature control; and
a control device configured to control the optical transmitter, wherein
the control device includes control signal generator configured to generate a control signal specifying a power value to be consumed by the heating element, and power generator configured to generate supply power being power of the power value.

6. The optical transceiver according to claim 5, wherein
the power generator is configured to supply the supply power directly to the heating element.

7. The optical transceiver according to claim 5, wherein
the power generator includes digital-to-analog converter configured to convert the control signal being a digital signal into an analog signal of the power value.

8. The optical transceiver according to claim 7, wherein
the heating element includes a heater resistor, and a resistance value of the heater resistor is defined based on drive capacity of the digital-to-analog converter.

9. The optical transceiver according to claim 5, wherein
the control signal generator is configured to generate, based on a relation between a wavelength of transmitted light being output from the optical transmitter and the power value, the control signal in such a way that the wavelength becomes a desired wavelength.

10. The optical transceiver according to claim 5, wherein
the optical transmitter further includes a wavelength-tunable light source and an optical modulator, and at least the wavelength-tunable light source is placed in proximity to the heating element.

11. A control method for an optical transmitter, comprising:
generating a control signal specifying a power value to be consumed by a heating element to be used for temperature control of an optical transmitter; and
generating supply power being power of the power value, according to the control signal.

12. The control method for an optical transmitter according to claim 11, wherein
the generating the supply power includes supplying the supply power directly to the heating element.

13. The control method for an optical transmitter according to claim 11, wherein
the generating the supply power includes converting the control signal being a digital signal into an analog signal of the power value.

14. The control method for an optical transmitter according to claim 11, wherein
the generating the control signal includes generating, based on a relation between a wavelength of transmitted light being output from the optical transmitter and the power value, the control signal in such a way that the wavelength becomes a desired wavelength.
